(19) United States
(12) Patent Application Publication
(10) Pub. No.: US 2013/0312121 A1
(43) Pub. Date: Nov. 21, 2013

(54) NON-AUTHENTIC DISC DEACTIVATION METHOD

(71) Applicant: John Matthew Town, Ojai, CA (US)

(72) Inventor: John Matthew Town, Ojai, CA (US)

(73) Assignee: THOMSON LICENSING, Issy de Moulineauz (FR)

(21) Appl. No.: 13/982,291

(22) PCT Filed: Mar. 2, 2011
(86) PCT No.: PCT/US11/00395

§ 371 Date: Jul. 29, 2013

(51) Int. Cl. G11B 23/28

(52) U.S. Cl. CPC G11B 23/281
USPC 726/33

(57) ABSTRACT

An optical disc undergoes authentication by reading a designated area on the optical disc containing authentication data. Following authentication, the designated area undergoes irradiation by the laser beam that reads the optical disc to erase recordable sectors in the designated area when the optical disc comprises a recordable disc to render unreadable data contained in the designated area for disc authentication.

### TECHNICAL FIELD

This invention relates to authentication of authentic pre-recorded optical discs and de-activation of non-authentic recordable optical discs used in place of authentic pre-recorded discs.

### BACKGROUND ART

Present day video game consoles have the capability of authenticating and playing pre-recorded authentic game discs. In view of the popularity of gaming consoles and the lucrative market for game discs, counterfeiting (pirating) of such discs occurs frequently. The illicit replication of game discs has proven difficult to stop because of the ready availability of inexpensive recordable optical discs that, using certain targeted techniques, can be recorded in such a way that the console will identify such a disc as an authentic pre-recorded disc. Once a game console identifies a recordable counterfeit disc as authentic, the game console will read the disc and allow playing of the game. A user who has a pirated disc capable of authentication by a gaming console has no need to acquire a legitimate disc.

Thus, a need exists for a technique for authenticating legitimate discs, but deactivating those which are not.

### BRIEF SUMMARY OF THE INVENTION

Briefly, in accordance with a preferred embodiment, a method for de-activating a counterfeit optical disc in accordance with the present principles commences by reading a designated area on the optical disc to obtain information for authenticating the disc. Upon disc authentication, the designated area undergoes heating. Heating of the designated area serves to erase recorded sector(s) in the designated area when the disc comprises a recordable disc, thereby rendering the data contained therein unreadable for authenticating the disc. This heating of the designated area will not harm an authentic pre-recorded disc but remains fatal to a non-authentic recordable disc.

### BRIEF DESCRIPTION OF THE DRAWINGS

FIG. 1 depicts a top view of an optical disc for authentication and deactivation (if necessary) in accordance with the present principles; and

FIG. 2 depicts a side-section view of the disc of FIG. 1 showing the deactivation of one or more recorded sectors when the disc comprises a recordable disc.

### DETAILED DESCRIPTION

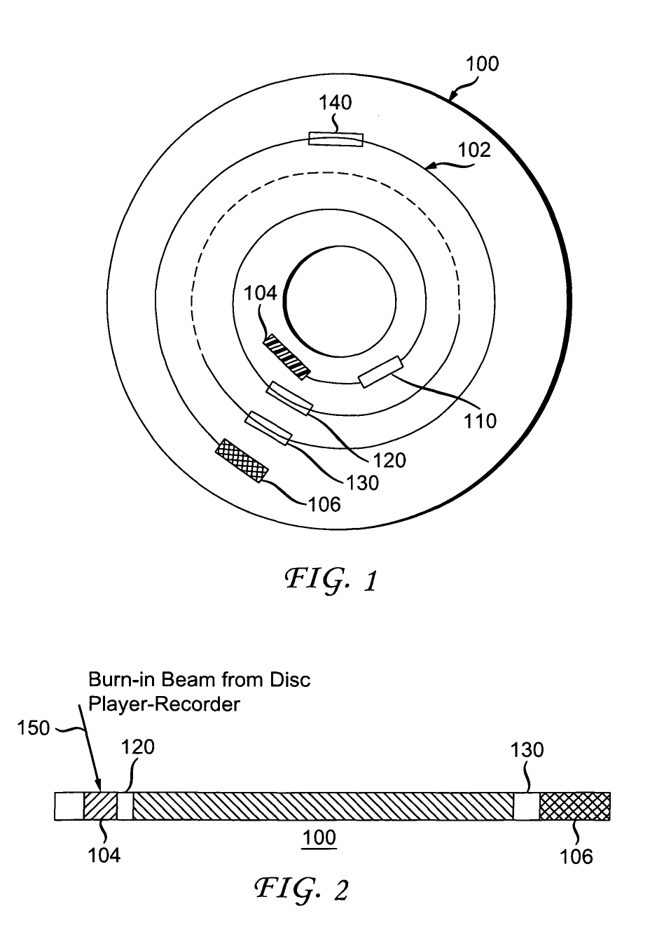

FIG. 1 shows a top view of an optical disc 100. The optical disc 100 can comprise a CD, DVD or Blu-ray disc which stores content appearing in a continuous spiral pattern 102. A lead-in area 104 exists at the beginning of the spiral pattern 102, and a lead-out area 106 exists at the end of the spiral 102. The lead-in area 104 generally comprises a control data zone containing control data such as physical format information, disc manufacturing information and content provider information which enables disc authentication. After reading the control data, a disc player/recorder (not shown) of the type existing within a game console (not shown) or other electronic device can authenticate the optical disc. After authentication, the disc player/recorder will access information stored on the disc in one or more of a plurality of content storage areas, illustratively depicted by areas 110, 120, 130 and 140. In the case of an optical disc for use by a game console, the content areas 110, 120, 130 and 140 of FIG. 1 will contain software, in the form of data and instructions. The software, when read by the disc player/recorder will undergo execution by a processor (not shown) within the game console to enable the user to play one or more games stored on the optical disc.

Rather than contain software, the program areas 110, 120, 130 and 140 could contain audio or audio-visual content. Typical game consoles allow a user to playback discs containing movies or other audio-visual content stored on the disc.

A game console user seeking a legitimate source of games will typically purchase a retail pre-recorded disc made and distributed directly by or under license from the original content owner or game developer. The term “pre-recorded” serves to define discs produced with content during the manufacturing process. Manufacturers of pre-recorded discs make such discs using well known techniques such as injection molding plastic replicas (“replication”) from a metal stamper made from a glass master recorded with the original authentic data.

While content owners and disc manufactures make use of a variety of anti-piracy techniques to prevent counterfeit replication/molding of pre-recorded discs, the widespread availability of inexpensive recordable discs and recorders has lead to a significant proliferation of “pirated” discs recorded with targeted custom recording software designed to circumvent the aforementioned anti-piracy techniques. Such pirated discs, once authenticated by a disc player/recorder within a game console will allow playing of a game just the same as if the disc were a legitimate, pre-recorded disc.

A recordable optical disc has at least one recording layer that may be an organic dye or inorganic/metallic layer. To record on a recordable optical disc, a disc player/recorder will subject the dye layer to a laser beam to physically alter the layer properties to burn a pattern corresponding to a binary bit sequence representing the information for recording. During playback, the disc player/recorder will read the pattern burned into the recording layer to reproduce the bit sequence representing the recorded information. Subsequent heating of the recording layer (burn-in) by a laser beam will cause further alteration of the recording layer properties and will typically render previously burned-in data permanently unreadable.

Referring to FIG. 2, which show a cross section of the optical disc of FIG. 1, the heat sensitivity of pre-recorded discs can be used to deactivate non-authentic discs in accordance with the present principles. Like reference numbers appear in FIG. 2 to identify elements in common with the optical disc 100 of FIG. 1. The de-activation method of the present principles addresses the use of non-authentic pirate recordable discs in games consoles and other electronic devices. The method commences by first authenticating a disc inserted into a disc player/recorder of a game console or other electronic device. Authentication occurs in a well known manner by reading data in the control zone in the lead-in area 104. Ordinarily, a game console or other electronic device whose disc player/recorder authenticated a disc would then treat the disc as authentic regardless of whether the disc actually comprised a counterfeit recordable disc.

In accordance with the present principles, following authentication, the disc player/recorder within a game console or other electronic device will receive instructions to apply a high-power burn cycle, via laser beam 150 in FIG. 2, to an authenticated disc in a critical area of the disc required to boot or authenticate the disc, such as the lead-in area 104 of FIG. 2. The burn cycle performed by applying laser beam 150 to the lead-in area 104 serves to destroy or erase the data structure of a recordable disc within the lead-in area. Typically optical discs (CD, DVD and Blu-ray) include a critical lead-in or control data section at the inner radius of the primary or first data layer, depicted as lead-in area 104. This area includes critical data for the recognition, identification, authentication and booting of the optical disc 100. The burn-in cycle will have no permanent effect on a pre-recorded disc because only recordable discs are inherently heat-sensitive and subject to permanent deformation/erasure at elevated temperature.

The deactivation method of the present principles takes advantage of the key property of recordable optical discs. As discussed, recordable discs undergo recording upon exposure to a high-power laser beam generated by the optical disc player/recorder. As discussed above, recordable discs feature a recording layer made from an organic or inorganic material designed to absorb laser energy to effect a permanent physical or structural change in the recording layer. Pre-recorded discs lack such a recordable layer and, as such, remain impervious to the effect of a recording laser beam.

Most optical disc drives today can function both as a recorder and player with the capability to write and playback optical discs. Many optical disc applications including today's game consoles allow for a high degree of control over the disc player/recorder to permit varying of the power of the laser beam for reading data from the disc. Increasing the intensity of the laser beam used to read the optical disc to a level sufficient to alter the recordable layer will deactivate a counterfeit pre-recorded disk notwithstanding the authentication of that disk by a game console or other electronic device.

The foregoing describes a technique for deactivating an authenticated but counterfeit recordable optical disc.

1. A method for deactivating a counterfeit/pirated non-authentic optical disc, comprising the steps of:
reading a designated area on the optical disc to obtain information for authenticating the disc, and upon disc authentication, then
heating the designated area to erase recordable sectors in the designated area when the disc comprises a recordable disc to render unreadable the data contained in the designated area for disc authentication.

2. The method according to claim 1 wherein the reading step comprises the step of irradiating the designated area with a laser beam.

3. The method according to claim 1 wherein the heating step comprises the step of irradiating the designated area with a laser beam.

4. The method according to claim 2 wherein the heating step comprises the step of irradiating the designated area with the laser beam which irradiates the designated area read to obtain the information for authenticating the optical disc.

5. The method according to claim 1 wherein the step of irradiating the designated area with the laser beam includes the step of adjusting one of laser beam intensity or power to erase recordable sectors in the designated area when the disc comprises a recordable disc.

6. A method for deactivating a counterfeit optical disc, comprising the steps of:
reading a designated area on the optical disc by a laser beam to obtain information for authenticating the optical disc, and upon disc authentication, then
heating the designated area by the laser beam that reads the optical disc to erase recordable sectors in the designated area when the optical disc comprises a recordable disc to render unreadable data contained in the designated area for disc authentication.
